(19) United States
(12) Patent Application Publication
(10) Pub. No.: US 2020/0331501 A1
(43) Pub. Date: Oct. 22, 2020

(54) Driver Assistance System, Transportation Device and Method for Sleep Phase-Specific Operation of a Transportation Device

(71) Applicant: Volkswagen Aktiengesellschaft, Wolfsburg (DE)

(72) Inventor: Alexander Wirtz, Braunschweig (DE)

(73) Assignee: Volkswagen Aktiengesellschaft, Wolfsburg (DE)

(21) Appl. No.: 16/629,800

(22) PCT Filed: Jul. 2, 2018
(86) PCT No.: PCT/EP2018/067837

§ 371 Date: Jan. 9, 2020

(30) Foreign Application Priority Data
Jul. 14, 2017 (DE) 10 2017 212 111.4

(51) Int. Cl. B60W 60/00; B60W 50/00; B60W 40/08; B60W 30/02; B60N 3/00; B60W 10/08; B60W 10/30; G01C 21/34

(52) U.S. Cl. CPC B60W 60/00133; B60W 50/0098; B60W 40/08; B60W 30/025; B60N 3/008; B60W 10/08; B60W 2420/54; G01C 21/3453; B60W 2552/00; B60W 2420/42; B60W 2540/221; B60W 2520/105; B60W 10/30

(57) ABSTRACT

A driver assistance system, a computer program product, a sequence of signals, a transportation device and a method for sleep phase-specific operation of a transportation device are proposed. The method in some embodiments comprises the following steps:
determining a sleep phase of a first occupant of the transportation device using sensors and, depending on the sleep phase;
adjusting a guidance of the transportation device.

### CROSS-REFERENCE TO RELATED APPLICATIONS

This application claims priority to German Patent Application No. DE 10 2017 212 111.4, filed on Jul. 14, 2017 with the German Patent and Trademark Office. The contents of the aforesaid Patent Application are incorporated herein for all purposes.

### TECHNICAL FIELD

The present invention relates to a driver assistance system, a computer program product, a sequence of signals, a transportation device and a method for sleep phase-specific operation of a transportation device.

### BACKGROUND

Vehicles that can be driven in an automated manner are known in the prior art. In the course of the automation of individual passenger traffic, it is to be expected that the users will feel the need to use the time on board a transportation device for working or resting.

With the current technical possibilities, outside meetings out of town are usually combined with an overnight stay in a hotel and then driving home. This process is time- and cost-intensive and often stressful as well. Normally, the user drives with his vehicle from location A to location B, has the meeting, spends the night in a hotel and drives back with his vehicle from location B to location A the next morning. This requires a large time commitment and incurs costs for the drive and additionally for the hotel.

https://www.pcwelt.de/produkte/GPS-Wecker-fuer-Pendler-iNap-472430.html discloses an alarm which, depending on a geographic position (e.g. 2 km before reaching a target position) outputs a message to a user so that the user can prepare themselves for arrival.

https://www.wohnmobilforum.de/w-t96574,start,45.html discusses the possibility of driving on the highway with a motor home, switching on an autopilot and sleeping during the drive.

### SUMMARY Objects exist to support sleeping on board a transportation device in the best manner possible and/or to design sleeping on board a transportation device in as restful a manner as possible.

The object mentioned above is solved by a method for sleep phase-specific operation of a transportation device according to claim 1.

The transportation device may be, for example, a street-legal vehicle. Alternatively or additionally, it may for example be a water vehicle or an air vehicle.

The details of one or more embodiments are set forth in the accompanying drawings and the description below. Other features will be apparent from the description, drawings, and from the claims. The dependent claims show further embodiments.

### BRIEF DESCRIPTION OF THE DRAWINGS

IN THE FIGS.:

FIG. 1 is a schematic representation of an exemplary embodiment of a transportation device with an exemplary embodiment of a driver assistance system;

FIG. 2 is a schematic representation of a driving situation of two transportation device communicating route-specific information according to an exemplary embodiment; and

FIG. 3 is a flow diagram illustrating steps of an exemplary embodiment of a method for sleep phase-specific operation.

### DETAILED DESCRIPTION

In a first step of an exemplary method of sleep phase-specific operation according to a first aspect, a sleep phase of a first occupant of the transportation device is determined using sensors. In other words, the (type of) sleep phase in which the occupant currently finds himself is checked. Optionally, the requirements of the sleep phase or of the occupant in the sleep phase may also be determined from the environment. Due to the requirements, the guidance of the transportation device may be correspondingly adjusted in a second step to support the sleep phase in the best manner possible or at least to disrupt it as little as possible. For example in the case that the sleep phase indicates a light sleep of the occupant, the guidance of the transportation device can take place more cautiously or more defensively, while in sleep phases of more robust sleep the guidance of the transportation device can be adjusted. For example, the guidance may now be oriented more offensively or closer to the purpose of travel. Thus, transportation oriented toward the purpose of travel is ensured with a more restful sleep.

In some embodiments, the sleep phase of a second occupant of the transportation device may be conveyed and further occupants of the transportation device may be as well. Depending on all simultaneous sleep phase categories, the guidance of the transportation device can then be adjusted. For example, if at least one occupant has a light sleep, a defensive or cautious guidance of the transportation device can take place, although other occupants are already sleeping more soundly.

In some embodiments, the priority with which the sleep phases of the individual occupants should be weighted against each other can be predefined. For example, one occupant may have an important meeting the next day, while the others can rest while strolling through the city. Correspondingly, it can at least be ensured that the occupant who has the important meeting the next day is sleeping deeply before a faster guidance of the transportation device takes place.

The ego transportation device may for example receive information regarding the upcoming stretch of road. This may take place, for example, from another transportation device (which is driving ahead of the ego transportation device) or other transportation device and/or stationary sensors. For example, roadway data (acceleration values of the transportation device on the upcoming stretch of road) and/or noise sources may be analyzed and made available to the ego transportation device for adjustment of its guidance. This may take place, for example, through car-to-car and/or car-to-X communication. In this manner, a best possible information basis for the anticipatory adjustment of the guidance of the transportation device can be created.

In some embodiments, the position of a seat/of an occupant's place in the transportation device may also be determined automatically. For this purpose, sensors can report the current seat setting or setting of the sleeping accommodation of the occupant or occupants and the guidance of the transportation device can be adjusted depending on the determined seat position. For example, an upright backrest can indicate that the user/occupant is not currently thinking of sleeping or is not definitively thinking of sleeping. Correspondingly, in such a situation a faster transportation can take place than if the seat is located in a substantially horizontal position, through which the user's desire to rest can be recognized.

In some embodiments, a predefined arrival time of the transportation device may be evaluated. The predefined arrival time may be a desired arrival time (e.g. a predefined time before a, for example, digitally predefined meeting of an occupant).

Depending on the arrival time, the guidance of the transportation device may be adjusted in such a way that the guidance of the transportation device is designed to arrive at the destination at the predefined arrival time in as efficient a manner as possible. In this manner, the travel speed may be reduced, the air and roll resistance may be minimized and the efficiency of the trip can be maximized. This aspect may be an independent aspect independent of the determination of the sleep phases and the other method steps mentioned above. In particular, this aspect may, however, be used in conjunction with the sleep phase determination and/or a method aspect mentioned above, multiple method aspects mentioned above or even all the method aspects mentioned above. Here the consideration of the sleep phases may be more heavily weighted the more sure it is that the destination will be reached on time at the predefined arrival time. For example, in the case that traffic news predicts an uncertain traffic flow speed, however, the predefined arrival time may be weighted higher than the consideration of the sleep phase of the occupant in order to ensure an on-time arrival.

Taking the sleep phase of the occupant or sleep phases of the occupants into consideration may take place, for example, through the following measures. The acceleration of the transportation device may be (automatically) adjusted. The acceleration may be or comprise a longitudinal and/or transverse and/or vertical acceleration. In addition, chassis and/or damper settings may ensure that the accelerations of the passenger compartment or the sleeping accommodation and therefore of the occupants are kept low in particular when a light sleep is recognized. Speed and/or acceleration behavior and/or transverse guidance of the transportation device may be adjusted in order to transmit the lowest possible forces to the occupants. For this purpose, the engine control and/or the chassis setting may also be adjusted. Alternatively or additionally, the heating/air conditioning of the passenger compartment may be adjusted to the sleep phase. The route itself may also be recalculated if upcoming route sections that have been calculated previously are determined to be inappropriate for the current and/or upcoming sleep phase or sleep phases. For example, a less curving route may be used if the sleep of the occupant turns out to be lighter than previously estimated. On the other hand, a drive on the highway with higher flow noises, for example, may be avoided as long as the user has not reached a more robust deep sleep phase. The measures mentioned above for considering the sleep phase are exemplary and are not to be understood as exhaustive. They may be used individually or in any combination with each other in some embodiments.

The sleep phase may be determined, for example, by means of an interior camera, by means of a pressure sensor, by means of an acceleration sensor (in particular a three-axis acceleration sensor), by means of a blood oxygen sensor and/or by means of a microphone. The interior camera can determine movements of the user. The pressure sensor may be integrated, for example, into a sleeping accommodation in order to determine movements independently of the position of the occupant in relation to the interior camera. The acceleration sensor can determine vibrations (“snoring”) and other bodily noise events. The blood oxygen sensor may be attached, for example, to a finger of the user in order to determine the blood oxygen saturation of the user and assign it to a predefined sleep phase or sleep phase category. Breathing noises and snoring can also be determined by means of the microphone. The means for determining the sleep phase are also not to be understood as exhaustive or limiting and can be used individually or in any combination.

According to a second exemplary aspect, a driver assistance system is proposed for sleep phase-specific operation of a transportation device. The driver assistance system serves to support sleep on board the transportation device and for example make it more restful. It comprises a data input which may be designed, for example, as a BUS participant, as an electrical line, as an optical line or similar. The data input is configured to forward the received signals to an evaluation unit which may be designed, for example, as an electronic control unit, as a microcontroller, as a programmable processor or similar. The evaluation unit may automatically initiate the guidance of the transportation device or the recalculation of the route via a data output. In this manner, the evaluation unit is configured to determine a sleep phase of a first occupant of the transportation device in conjunction with the data input and to automatically adjust a guidance of the transportation device depending on the sleep phase of the first occupant or other occupants in conjunction with the data output. In this manner, the driver assistance system is accordingly configured to execute the features, feature combinations and the resulting benefits of the method explained in a corresponding manner, so that reference is made to the embodiments above in order to avoid repetitions.

According to a exemplary third aspect, a computer program product (e.g. a data memory) is proposed on which instructions are stored that enable a programmable processor or an electronic control unit to execute the steps of a method according to the first aspect. The computer program product may be designed, for example, as a CD, DVD, Blu-ray Disc, flash memory, hard drive, RAM/ROM, cache, etc.

According to a fourth exemplary aspect, a sequence of signals is proposed which represent instructions that, when they are executed on a programmable processor, enable the processor to perform the steps of a method according to the first aspect. This way, the informational provision of the instructions is also placed under protection in case of the storage means required for this purpose are outside the scope of the accompanying claims.

In a fifth aspect, a transportation device is proposed which may be designed, for example, as a passenger vehicle, van, truck, air and/or water vehicle. The transportation device may be configured to execute the steps of the method according to the first aspect. With respect to features, feature combinations, and embodiments of the present aspect reference is made to the embodiments discussed above in order to avoid repetitions.

Once it is possible with automated driving to travel with “level 5” (with this automation level a driver is no longer necessary), the possibility exists of sleeping while driving. In this case, the passenger compartment may resemble a driving hotel room. In the driving hotel room, one to two people can autonomously drive or be driven over long distances in a lying/sleeping position and sleep restfully while doing so. For example, after a meeting in a distant city, instead of ordering a taxi to the hotel the user simply orders a “sleeping car”. After getting in, the occupant sleeps for the entire journey and is woken again shortly before arrival. In contrast to previous vehicles, the drive may be used for sleeping and the passenger compartment may be used as a sleeping car. The passenger compartment may dispense with conventional seats if the passenger expresses the desire to sleep for the entire drive. The vehicles may be prepared for each guest like conventional hotel rooms. In other words, the beds are made, the mini-bar is filled and extensive cleaning is performed before the passenger enters the passenger compartment. This may take place, for example, in collaboration with hotel chains. The present teachings can build on a basic vehicle with all functions and the required space. For example, a van with a sufficient surface area in its passenger compartment for installing sleeping accommodations can be used. Just as airlines use special seats, interior, furnishings and paints in their airplanes, these “sleeping cars” (transportation devices) also receive this special hotel furnishing. The special vehicles may be designed in the style of a hotel chain and have similar furnishings as a hotel room. For example, a comfortable bed, a television, an ambient light, a panoramic roof, a mini-bar and other interior decoration objects of conventional hotel rooms may be present. These vehicles may be ordered using an application (“app”), e.g. by means of a smartphone, or provided directly by the operating hotel chain. The destination may be entered in a conventional manner (text input, speech input or similar) and provided with a waking time (e.g. 15 minutes before arrival, 5 km before arrival or similar) as needed. The preparation of the sleeping cars may occur in the areas of the hotel parking garage. In other words, the infrastructure required to care for the conventional hotel rooms may also be used to care for the sleeping cars proposed herein, whereby synergies keep the costs of provision low. As an example, the laundry service, the catering, the room cleaning and the charging/filling of an energy store are named, whereby the additional effort may turn out to be exceedingly low. In order to ensure the possibility of driving for longer distances, electrical drive versions comprising a fuel cell can be considered. Special supply points on highways may also be used that are automatically driven to after a corresponding user desire/occupant desire has been expressed. Shielded sanitary facilities may be available here. A coupling to existing infrastructures such as, for example, airports would also be possible. The passengers may be driven to the direct vicinity of the check-in counters responsible for them, whereby the paths may be kept short and convenient and the travel time may be reduced.

The present invention makes possible the combination of two phases of a business trip that have previously been separate. The overnight stay and the subsequent drive home may take place simultaneously and conveniently. With the transportation device as discussed herein, not only relaxation but a restful sleep on the way home or to the next meeting is possible.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate figures. It is further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

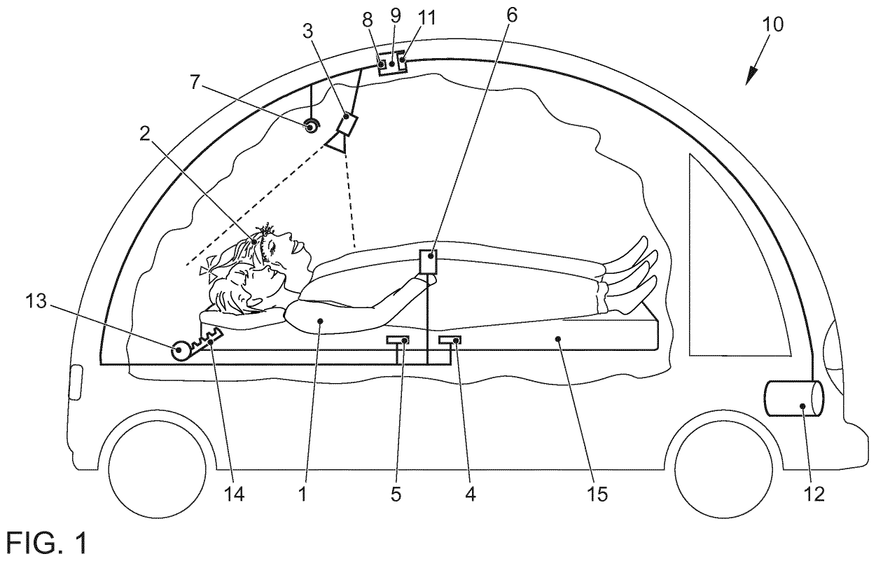

FIG. 1 shows a partial cross-section view of an exemplary embodiment of a sleeping car 10 as a transportation device, within a user and another user are lying on a mattress of a bed 15. Both are located in the detection range of an interior camera 3 by means of which movements of the users 1, 2 can be detected. Moreover, a pressure sensor 4 and an acceleration sensor 5 are integrated into the mattress. The information determined by the acceleration sensor 5 and the pressure sensor 4 are sent via a data line along with the recordings from an interior microphone 7 to the data input 8 of an electronic control unit 9 as an evaluation unit. The position of a toothed rack 14, by means of which the orientation of the bed 15 can be adjusted via an electric motor 13, can also be used to determine a sleep phase of the users 1, 2 via the data input 8 through the electronic control unit 9. After the (probable) sleep phase category has been determined, an electric motor 12 can be actuated via a data output 11 in order to adjust the longitudinal acceleration and the transverse acceleration of the sleeping car 10 to the current sleep phase.

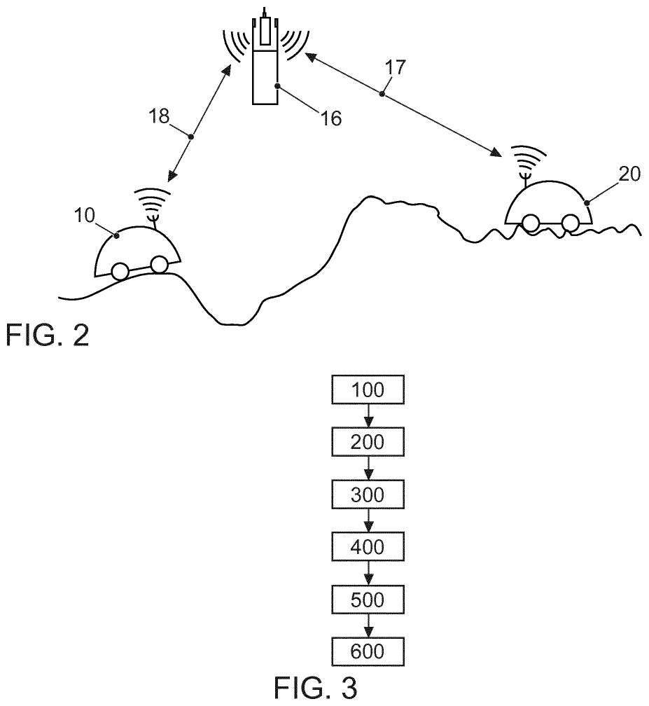

In FIG. 2, a scenario is shown in which a sleeping car 10 already presented in FIG. 1 communicates with a passenger vehicle 20 that is driving ahead via a wireless communication connection 17, a transmission tower 16 and a communication connection 18. The passenger vehicle 20 that is driving ahead drives over an uneven roadway, whereby tremors or vibrations or changes in acceleration occur which, depending on the sleep phase of an occupant sleeping in the sleeping car 10, must be perceived as disruptive or endangering to the sleep. In order to avoid the negative influences on the sleep of the occupant, a recalculation of the route in response to the insight determined by the passenger vehicle 20 can be carried out to bypass the uneven stretch of road driven by the passenger vehicle 20 and/or an adjustment of the chassis as well as the travel speed can be carried out in order to alleviate the disadvantageous effect on the sleep of the users or to completely bypass it.

FIG. 3 shows steps of an exemplary embodiment of a method for sleep phase-specific operation of a transportation device. In a first step, a sleep phase of a first occupant of the transportation device is determined using sensors. In step 200, corresponding determinations are also made for a second occupant and if necessary further occupants of the ego transportation device. In step 300, information regarding the roadway data and the noise sources on an upcoming stretch of road are determined by another transportation device and provided to the ego transportation device. In addition, in step 400, a seat position of the transportation device is determined, with the aid of which a conclusion can be drawn about the intention of the user to sleep or simply to rest. In step 500, a predefined arrival time is evaluated as a desired arrival time of the user of the transportation device. This can take place, for example, through known navigation-related algorithms. Depending on the expected travel time and traffic flow predictions, a required (average) travel speed can now be determined and a corresponding planning of the travel speed, the travel route and the simultaneous consideration of the sleep phases of the occupants of the transportation device can take place. Finally, in step 600, the guidance of the transportation device can be adjusted based on the previously determined insights. The user therefore reaches the desired destination well-rested and on time and avoids a costly and time-consuming hotel stay.

### LIST OF REFERENCE NUMERALS

1 User

2 User

3 Interior camera

4 Pressure sensor

5 Acceleration sensor

6 Blood oxygen sensor

7 Interior microphone

8 Data input

9 Electronic control unit

10 Sleeping car

11 Data output

12 Electric motor (traction machine)

13 Electric motor (for sleep position adjustment)

14 Toothed rack

15 Bed

100—

600 Method steps

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for sleep phase-specific operation of transportation device comprising the steps of:
determining a sleep phase of a first occupant of the transportation device using sensors and, depending on the sleep phase;
adjusting a guidance of the transportation device.

2. The method of claim 1, further comprising:
determining a sleep phase of a second occupant of the transportation device using sensors and, depending on the sleep phase of the second occupant as well as depending on the sleep phase of the first occupant,
adjusting the guidance of the transportation device.

3. The method of claim 1, comprising:
receiving information, in particular regarding one or more of roadway data and noise sources, on a stretch of road ahead of the transportation device and, depending on the information,
adjusting the guidance of the transportation device.

4. The method of claim 1, further comprising:
determining a seat position of the transportation device and, depending on the seat position,
adjusting the guidance of the transportation device.

5. The method of claim 1, further comprising:
evaluating a predefined arrival time of the transportation device; and
considering the predefined arrival time when adjusting the guidance of the transportation device.

6. The method of claim 1, wherein the guidance of the transportation device is adjusted with regard to one or more of the group of acceleration, damper setting, longitudinal guidance, transverse guidance, motor control, chassis setting, heating/air conditioning, and a route to be used.

7. The method of claim 1, wherein the determination of the sleep phase takes place using one or more of the group of an interior camera, a pressure sensor, an acceleration sensor, a blood oxygen sensor, and a microphone.

8. A driver assistance system for sleep phase-specific operation of a transportation device, comprising
a data input;
an evaluation unit; and
a data output; wherein
the evaluation unit is configured
to determine a sleep phase of a first occupant of the transportation device in conjunction with the data input; and
adjust a guidance of the transportation device depending on the sleep phase in conjunction with the data output.

9. The driver assistance system according to claim 8, which is configured to execute the method of claim 1.

10. A non-transitory computer program product comprising instructions which, when they are executed on an evaluation unit of a driver assistance system, cause the evaluation unit to perform the steps of the method of claim 1.

11. A sequence of signals representing instructions which, when they are executed on an evaluation unit of a driver assistance system, cause the evaluation unit to perform the steps of the method of claim 1.

12. A transportation device comprising a sleeping accommodation, in particular a bed, and a driver assistance system of claim 8.

13. The transportation device of claim 12, wherein the transportation device is a transportation device that can be driven in an automatic manner.

14. The transportation device of claim 12, wherein the transportation device is a road vehicle.

15. The method of claim 3, wherein the information on a stretch of road relates to one or more of roadway data and noise sources.

16. The method of claim 2, comprising
receiving information on a stretch of road ahead of the transportation device and, depending on the information, adjusting the guidance of the transportation device.

17. The method of claim 2, further comprising
determining a seat position of the transportation device and, depending on the seat position,
adjusting the guidance of the transportation device.

18. The method of claim 3, further comprising
determining a seat position of the transportation device and, depending on the seat position,
adjusting the guidance of the transportation device.

19. The method of claim 15, further comprising
determining a seat position of the transportation device and, depending on the seat position,
adjusting the guidance of the transportation device.

20. The method of claim 2, further comprising
evaluating a predefined arrival time of the transportation device; and
considering the predefined arrival time when adjusting the guidance of the transportation device.
